(19) United States
(12) Patent Application Publication
(10) Pub. No.: US 2026/0116568 A1
(43) Pub. Date: Apr. 30, 2026

(54) IMPROVED SURFACE HEAT EXCHANGER FOR AN AIRCRAFT NACELLE

(71) Applicant: SAFRAN NACELLES, Gonfreville-L'Orcher (FR)

(72) Inventors: Xavier Cazuc, Moissy-Cramayel (FR); Jean-Nicolas Pierre Bouchout, Moissy-Cramayel (FR); Marc Aubree, Moissy-Cramayel (FR); Xavier Carcenac, Moissy-Cramayel (FR)

(21) Appl. No.: 19/474,146

(22) PCT Filed: Apr. 24, 2024
(86) PCT No.: PCT/FR2024/050540

§ 371 Date: Oct. 9, 2025

(30) Foreign Application Priority Data
Apr. 26, 2023 (FR) 2304226

(51) Int. Cl. B64D 33/08; B64D 29/00; F01D 25/12

(52) U.S. Cl. CPC B64D 33/08; B64D 29/00; F01D 25/12; F05D 2260/213

(57) ABSTRACT

This surface heat exchanger, in particular for an aircraft nacelle, comprises a first metal sheet and a second metal sheet assembled together and a plurality of distribution channels for a fluid disposed between the first metal sheet and the second metal sheet, the exchanger further comprising inlet and outlet interfaces for the fluid. The exchanger further comprises distribution means defining for each distribution channel a flow section of the fluid, each of the distribution channels being connected to the inlet and outlet interfaces by such a flow section, said distribution channels being distributed over the entire perimeter of the inlet and/or outlet interface.

### TECHNICAL FIELD

The present invention relates to the field of heat exchangers, in particular for fairings of an aircraft engine, called “nacelle”.

### PRIOR ART

Climate change is a major concern for many legislative and regulatory bodies around the world. Indeed, various restrictions on carbon emissions have been, are or will be adopted by various states. In particular, an ambitious standard applies to both new types of aircraft as well as those in circulation requiring having to implement technological solutions to make them compliant with the regulations in force. Civil aviation has been mobilizing for several years now to contribute to the fight against climate change.

Technological research efforts have already made it possible to significantly improve the environmental performance of aircraft. The Applicant considers the factors impacting in all design and development phases to obtain aeronautical components and products that are less energy-consuming and more environmentally friendly and the incorporation and use of which in civil aviation have moderate environmental consequences with a view to improving the energy efficiency of aircraft.

Consequently, the Applicant continuously works to reduce its negative climate impact through the use of methods and the exploitation of proper development and manufacturing processes and minimizing greenhouse gas emissions to the minimum possible to reduce the environmental footprint of its activity.

This sustained research and development work covers both the new generations of aircraft engines, the lightweighting of aircrafts, in particular through the materials used and lighter on-board equipment, the development of the use of electrical technologies to provide propulsion, and, indispensable complements to technological progress, aviation biofuels.

In general, an aircraft is propelled by one or more propulsion units each comprising an engine or turbojet engine housed in a tubular nacelle.

In general, the turbojet engine comprises a set of vanes rotated by a gas generator through a set of transmission means. The nacelle further comprises a lubricant-distribution system in order to ensure good lubrication of these transmission means and to cool them. Advantageously, the lubricant is oil.

In order to cool the lubricant, the nacelle generally comprises a cooling system comprising at least one heat exchanger. The cooling system is configured to circulate a fluid, for example the lubricant or a cooling liquid that will cool the lubricant.

There are air/lubricant heat exchangers that use air taken from a secondary duct of the compressor, but this leads to additional pressure drops.

There are also finned heat exchangers attached to one of the walls of the nacelle to cool the fluid by circulating the air in the secondary duct along the fins, but such a solution also generates significant aerodynamic losses.

These aerodynamic losses lead to increased fuel consumption.

Fluid-cooling systems comprising a structural surface exchanger, i.e. an exchanger without fins and forming an overall smooth contact surface with the fluid circulating outside the exchanger, so as to avoid the pressure drops caused by the presence of fins, are also known.

Such a structural surface exchanger generally comprises a first corrugated metal sheet and a second smooth metal sheet, assembled to form distribution channels that allow the flow of the cooling fluid from a distributor to a fluid manifold.

Such a heat exchanger also comprises one or more stiffeners disposed between the first and second metal sheets and configured to provide the structural strength of the exchanger.

However, the presence of the distributor and manifold increases the difficulty of forming the exchanger due to the risks of tearing the metal sheet.

Apart from the manufacturing difficulties mentioned, the current exchangers present risks of uneven distribution of flows between the different distribution channels, which degrades their thermal efficiency.

Moreover, stiffeners are singularities that disrupt flow and cause significant pressure drops.

### DISCLOSURE OF THE INVENTION

The present invention therefore aims to reduce the pressure drops inherent in the inlet/outlet interfaces of a heat exchanger and thus to improve the heat exchanges between respectively a fluid circulating inside and the air circulating outside said heat exchanger, while optimizing the structural strength of the heat exchanger.

The object of the invention is a heat exchanger, in particular for an aircraft nacelle, comprising a first metal sheet and a second metal sheet assembled together and a plurality of channels for distributing a fluid disposed between the first metal sheet and the second metal sheet, the heat exchanger further comprising fluid inlet and outlet interfaces for said fluid.

The exchanger further comprises distribution means for distributing the fluid defining for each distribution channel flow section of the fluid, each of the distribution channels being connected to the inlet and outlet interfaces by such a flow section, said distribution channels being distributed over the entire perimeter of the inlet interface and/or the outlet interface.

Such an exchanger improves the flow of fluid between the interfaces and the distribution channels and makes it possible to control the distribution of flows between the distribution channels.

Advantageously, said flow section defined for each distribution channel has a value that depends on the length of said channel, so as to homogenize the flow rates of the distribution channels with each other.

Such a definition of the flow section makes it possible to control the distribution of flows between the distribution channels.

For example, said plurality of channels comprise a first channel and a second channel with different cross-sections.

Advantageously, the exchanger comprises a plate fastened to the second metal sheet and provided with studs disposed between the second and first metal sheets, so as to secure the interfaces to the first and second metal sheets by means of fastening means cooperating with the studs.

Such fastening means are for example screws, bolts, rods or rivets.

Preferably, the studs comprise threaded holes and the distribution means comprise a metal sheet provided with holes aligned with said threaded holes of the studs.

For example, the distribution means comprise vertical walls disposed between the studs and the distribution channels, the walls being of constant thickness and oriented radially with respect to a longitudinal axis of the inlet interface and/or of the outlet interface.

Such walls make it possible to improve the flow around the studs thereby reducing the pressure drops inside the heat exchanger.

For example, the distribution means comprise vertical walls of varying thickness disposed between the studs and the inlet and outlet ends of the distribution channels, so as to reduce turbulence due to the flow of the fluid.

Advantageously, the distribution means comprise leading edges and trailing edges formed by circular arcs, the convexity of the arcs being directed towards a center of the plate.

According to another feature, the plate is provided with throttle members intended to be placed in inlet ends and/or in outlet ends of the distribution channels, so as to create a reduction in the useful section of the channels at the location of the throttle members.

According to another aspect, the invention relates to a turbine engine nacelle comprising at least one heat exchanger as described above.

### BRIEF DESCRIPTION OF THE DRAWINGS

Other aims, features and advantages of the invention will appear upon reading the following description, given only as a non-limiting example, and made with reference to the appended drawings wherein:

FIG. 1 is a schematic view of a surface heat exchanger according to an embodiment of the invention;

FIG. 2 is a detail view in partial section of the exchanger of FIG. 1;

FIG. 3 and FIG. 4 are respectively a partial sectional view and a plan view of a connection to an inlet or outlet interface of an exchanger according to an embodiment of the invention;

FIG. 5 illustrates a plan view of a connection to an inlet or outlet interface of an exchanger according to a second embodiment of the invention;

FIG. 6 illustrates a plan view of a connection to an inlet or outlet interface of an exchanger according to a third embodiment of the invention;

FIG. 7 illustrates a plan view of a connection to an inlet or outlet interface of an exchanger according to a fourth embodiment of the invention;

FIG. 8 is a perspective view of a plate of an exchanger according to a fifth embodiment of the invention;

FIG. 9 is a partial sectional view of a throttling member of the plate of FIG. 8;

FIG. 10 is a plan view of the distribution means illustrating the principle of variation in flow section Sp for a channel as a function of the length of the channel; and

FIG. 11 is a schematic view of a nacelle equipped with a heat exchanger according to one of the embodiments of the invention.

### DETAILED DISCLOSURE OF AT LEAST ONE EMBODIMENT

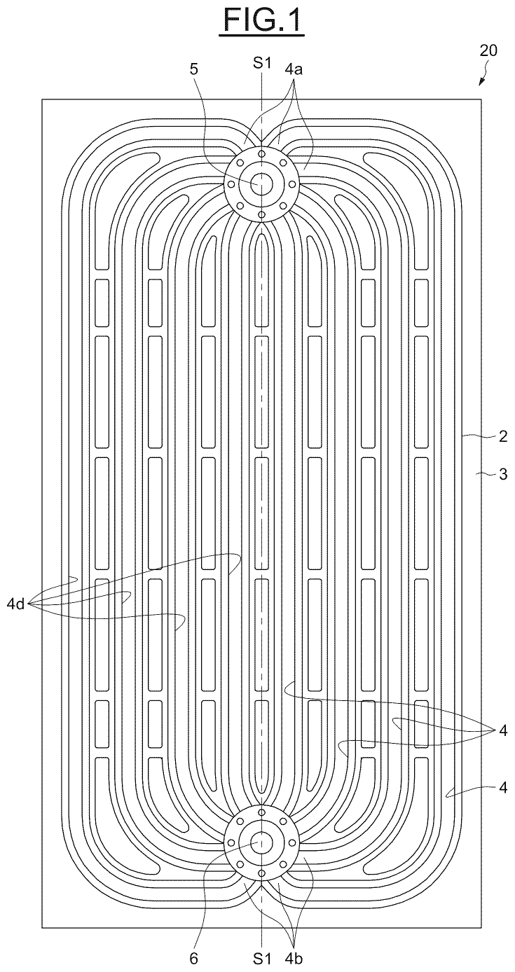

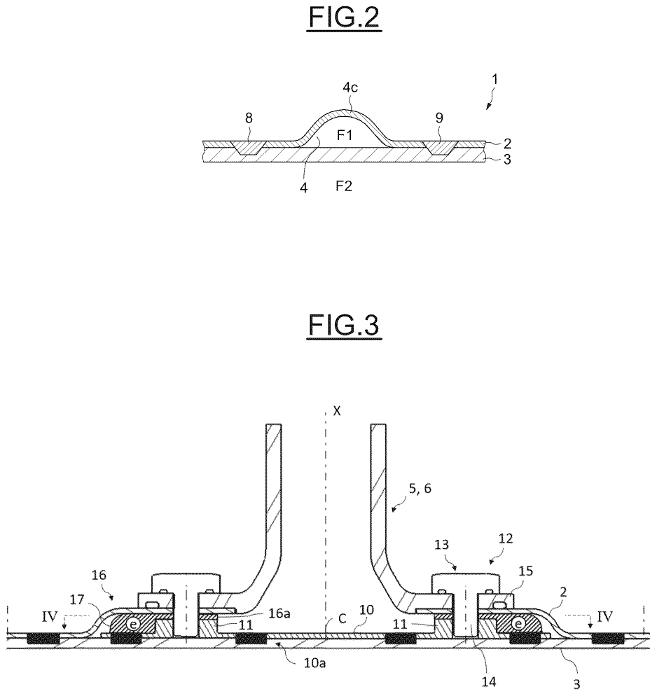

With reference to the example illustrated in FIGS. 1 and 2, a heat exchanger 1 comprises a first skin or metal sheet 2 and a second skin or metal sheet 3.

The first metal sheet 2 comprises a plurality of corrugations 4c and the second metal sheet 3 is herein flat.

The exchanger 1 comprises a plurality of distribution channels 4 each delimited by a corrugation 5 of the corrugated first metal sheet 2 and the so-called second smooth metal sheet 3.

The exchanger 1 is a heat exchanger between a first fluid F1 and air F2. The fluid F1 is intended to circulate in the channels 4 and the air F2 is intended to circulate in contact with the second smooth metal sheet 3.

Each distribution channel 4 has a cross-section in a semicircle. Alternatively, provision could be made for the section to have any general shape.

As illustrated, the distribution channels 4 have cross-sections with a size identical to each other.

Alternatively, sections with different sizes between each of the channels could be provided.

The distribution channels 4 are respectively connected to an inlet interface 5 and to an outlet interface 6.

In other words, there is no collector and distributor located between the channels 4 and respectively the inlet 5 and outlet 6 interfaces.

In this description, the inlet and outlet are defined in relation to the normal flow direction of the cooling fluid in the exchanger.

As illustrated on FIG. 1, the inlet ends 4a of the distribution channels 4 are distributed uniformly, i.e. evenly, over the entire perimeter of the inlet interface 5, and the outlet ends 4b of the distribution channels 4 are distributed uniformly over the entire perimeter of the outlet interface 6.

The inlet ends 4a of the channels 4 and the outlet ends 4b of the channels 4 have a curved shape.

The inlet ends 4a and the outlet ends 4b are connected together by a rectilinear portion 4d.

In the embodiment illustrated in FIG. 1, the exchanger 1 comprises an anterior-posterior symmetry axis S1-S1 passing through the inlet interface 5 and the outlet interface 6 and a transverse symmetry axis S2-S2 perpendicular to the axis S1-S1. The distribution channels 4 are disposed symmetrically with respect to said symmetry axis S1-S1. The concavity of the inlet ends 4a and the outlet ends 4b of the channels 4 is directed towards the center of the exchanger 1 formed by the intersection of the two symmetry axes S1-S1 and S2-S2.

In a variant, it is still possible for the exchanger not to have a symmetry axis. The first and second metal sheets 2, 3 are assembled by a welding or brazing zone 8, 9 on either side of the corrugation 4c of the corrugated metal sheet 2. Said welding or brazing zone 8, 9 extends from the first metal sheet 2 up to the second metal sheet 3 (FIG. 2).

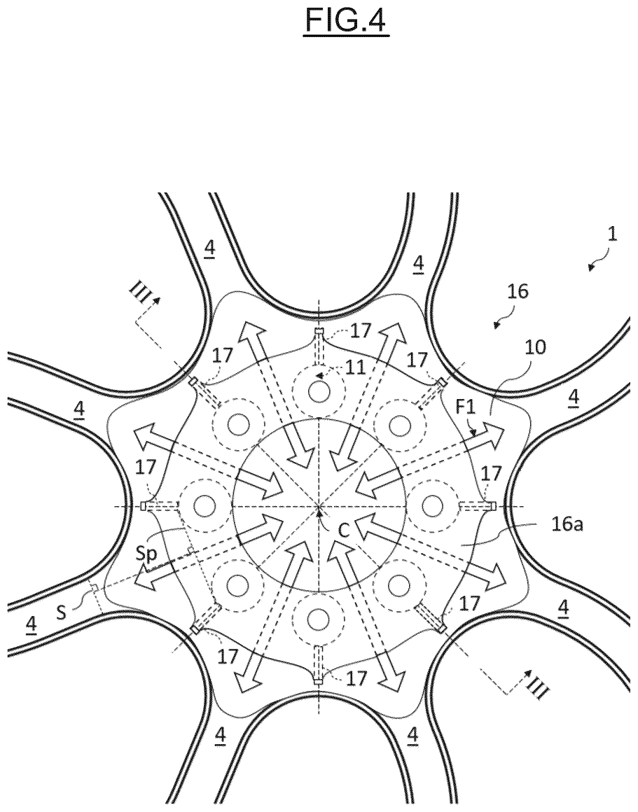

FIG. 3 is a partial cross-sectional view of the connection of an inlet 5 or outlet 6 interface to the first 2 and second 3 metal sheets, according to the invention. With reference to the example illustrated in FIGS. 3 and 4, the heat exchanger 1 comprises a plate 10 fastened to the second metal sheet 3, preferably by welding with beads 10a.

The plate 10 is provided with studs 11 arranged between the second 3 and the first 2 metal sheets and between the corrugations 4c of the first metal sheet 2. The studs 11 here have a cylindrical cross-section.

The connection is made with screws 12 each comprising a head 13 and a threaded rod 14.

The threaded rods 14 pass through a base 15 of the interface 5, 6 and the first metal sheet 2 and work together with corresponding threads provided on the studs 11, so as to clamp the base 15 and the first metal sheet 2 between the heads of the screws 12 and the studs 11.

The exchanger 1 comprises eight distribution channels 4 distributed over the entire circumference of the inlet 5 or outlet 6 interface (FIG. 4). In a variant, the heat exchanger 1 could comprise a different number of distribution channels 4, for example greater than or equal to three.

The heat exchanger 1 further comprises distribution means 16 for distributing the fluid F1.

The flow of the fluid F1 is schematically represented by the arrows connecting an interface 5, 6 and the distribution channels 4. Naturally, the flow direction depends on the type of interface. Thus, the direction of flow goes from an inlet interface 5 to distribution channels 4 and from distribution channels 4 to an outlet interface 6.

The distribution means 16 define for each distribution channel 4 a flow section Sp of the fluid F1, each channel 4 being connected to the inlet 5 and outlet interface 6 by such a flow section Sp. Preferably, the area of the flow section Sp can be adjusted for each distribution channel 4. This makes it possible to control the distribution of fluid flow between the various distribution channels.

The flow section Sp of a distribution channel 4 is the useful section allowing the flow of the fluid F1 to or from this channel.

Preferably, the flow section Sp is parallel to an inlet or outlet cross-section S of the corresponding distribution channel 4, so as to reduce the pressure drops. Preferably, the flow section Sp is centered with respect to the inlet or outlet cross-section S of the corresponding distribution channel 4, so as to reduce the pressure drops. For example, a flow section Sp is considered centered with respect to a cross-section S of a corresponding channel 4 when a radius that starts from the center C to this channel 4 and that passes at an equal distance from two neighboring distribution means 16 also passes through the respective centers of the sections Sp and S.

For example, to homogenize the flow rates between the distribution channels 4, the flow section Sp corresponding to a given distribution channel depends on the length of said channel. The length of a distribution channel 4 is understood to be the distance between the centers C corresponding to the inlet interface 5 and to the outlet interface 6, measured on the curvilinear axis of the distribution channel. For example, the flow section Sp is proportional to the length of the channel in particular when the distribution channels have identical cross-sections to each other. Thus, in the case of channels C1 and C2 of identical cross-section, an enlarged flow section Spe and a reduced flow section Spr are associated respectively with the channel C1 having a larger length and with the channel C2 having a smaller length (FIG. 10).

The distribution means 16 comprise a metal sheet 16a provided with holes aligned with the threaded holes of the studs 11 of the plate 10. This alignment facilitates the positioning of the distribution means 16 with respect to the plate 10 and allows the rods 14 of the screws 12 to pass through the metal sheet 16a to improve securing.

In the embodiment illustrated in FIGS. 3 and 4, the distribution means 16 comprise vertical walls 17 disposed between the studs 11 and the distribution channels 4. The walls 17 have a constant thickness e and are oriented radially with respect to a longitudinal axis X of the interface 5, 6 which intersects the plate 10 perpendicularly at the center C.

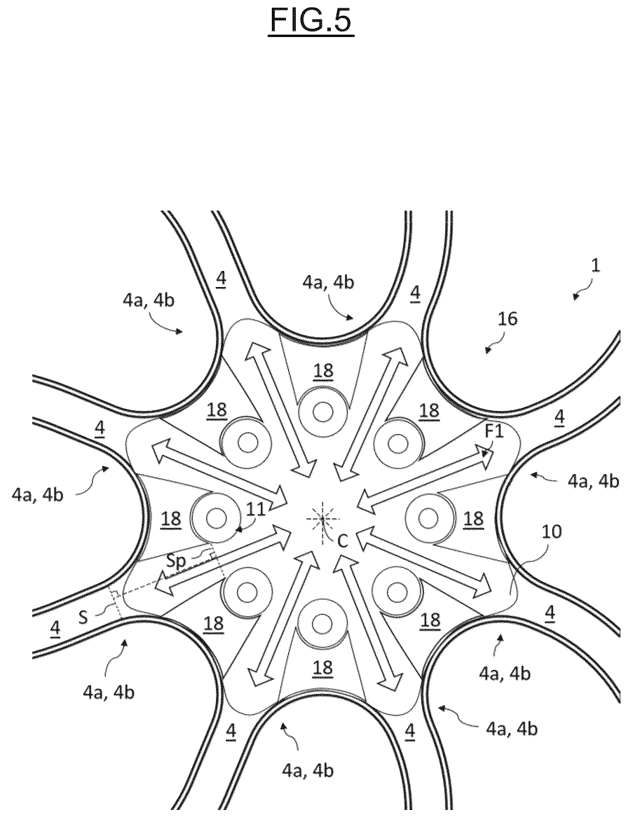

Another embodiment is illustrated in FIG. 5, on which the same elements bear the same references.

The embodiment illustrated in FIG. 5 differs from the embodiment illustrated in FIGS. 3 and 4 only in that the distribution means 16 comprise vertical walls 18 of variable thickness. The walls 18 are arranged between the studs 11 and the inlet 4a and outlet 4b ends of the distribution channels 4, so as to reduce the turbulence due to the flow of fluid F1.

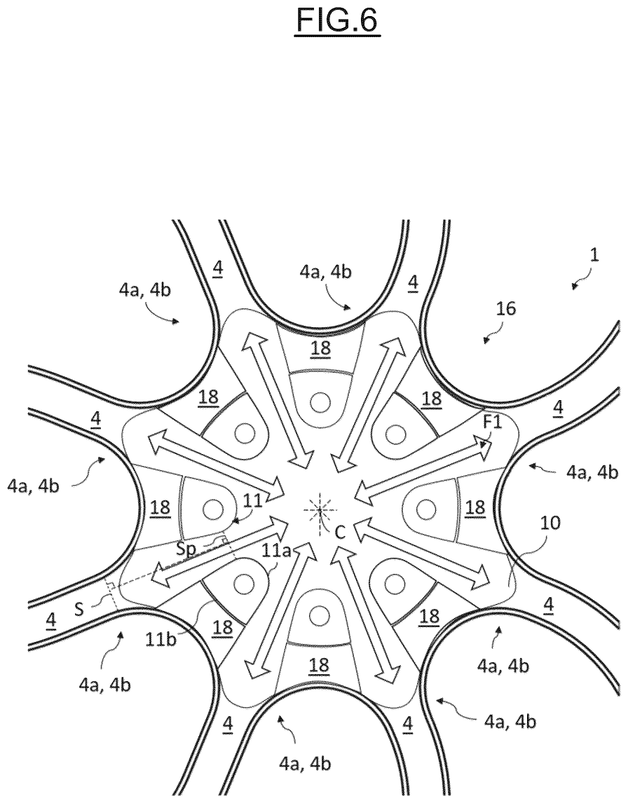

FIG. 6 illustrates another embodiment which differs from the embodiment illustrated in FIG. 5 solely in that the cross-section of each stud 11 comprises two opposing arcs of a circle 11a, 11b and connected by two straight-line segments, the arcs of the circle 11a, 11b having different radii from each other. In a variant, it is still possible to replace the two arcs of a circle 11a, 11b with other curved shapes, in particular ellipses or parabolas.

The studs 11 may be identical to each other, but alternatively it is still possible for them to be different.

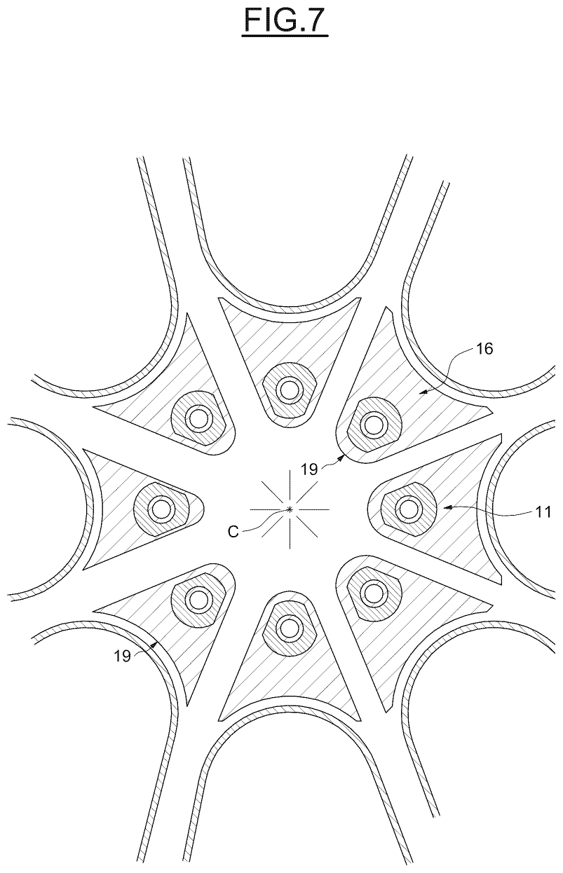

FIG. 7 illustrates another embodiment in which the distribution means 16 envelop the studs 11, so that the fluid F1 does not come into contact with the studs 11. The distribution means 16 comprise leading edges and trailing edges formed by arcs of a circle 19, the convexity of the arcs being directed towards the center C of the plate 10.

In a variant, it is still possible to replace the arcs of a circle 19 with other curved shapes, in particular ellipses or parabolas.

The metal sheet 16a has not been shown in FIGS. 5 to 7 in order not to overload the drawings and to facilitate understanding.

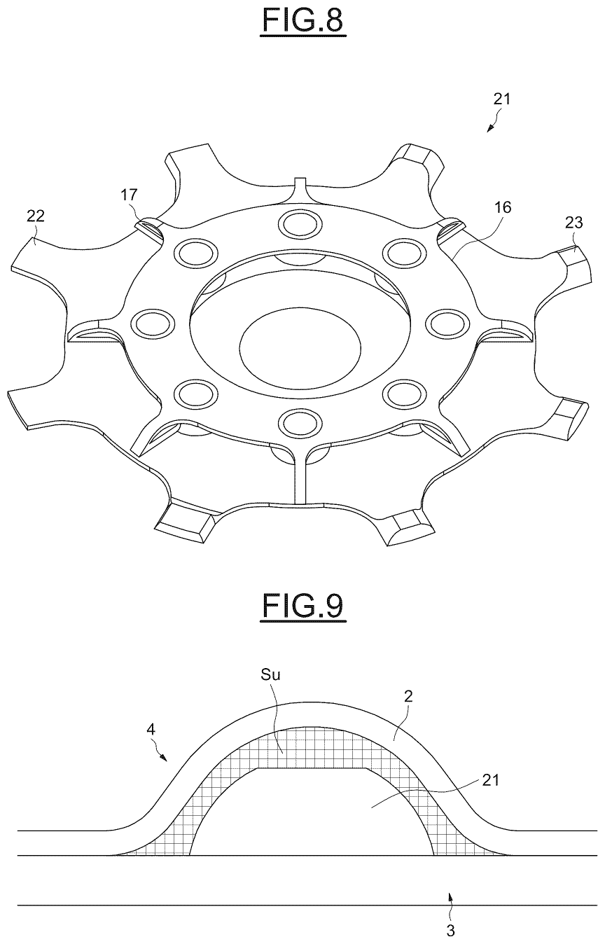

FIG. 8 is a perspective view of a plate 10 and distribution means 16 comprising vertical walls 17 of constant thickness. In the example illustrated in FIG. 8, the plate 10 comprises throttle members 21 intended to be placed in the inlet ends 4a and/or in the outlet ends 4b, so as to create a reduction in the flow section of the fluid. The size of the members 21 may vary from one channel 4 to another. In the example illustrated in FIG. 8, the plate 10 is provided with throttle members 21 the size of which varies between a minimum size 22 corresponding to the longest channel and a maximum size 23 corresponding to the shortest channel. The variable relative size of the throttle members 21 makes it possible to adjust the distribution of the fluid flow rates between the various distribution channels 4.

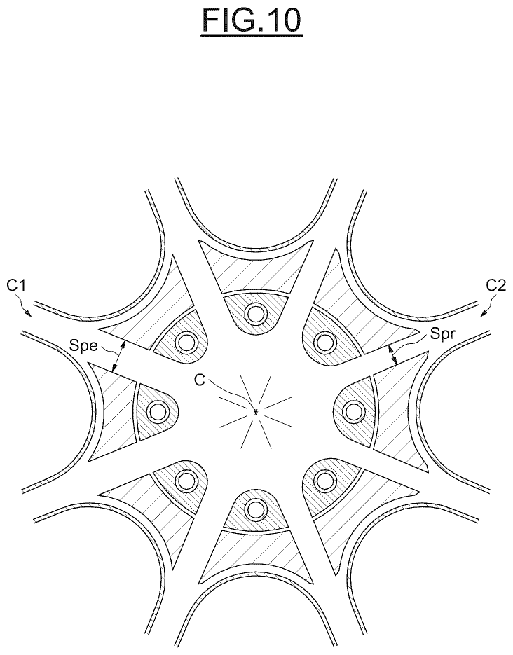

FIG. 9 is a cross-sectional view of a throttle member 21 disposed in a distribution channel 4. The presence of the throttle member 21 reduces the useful section Su of the channel 4. It should be noted, that as the cross-section of the throttle member increases, the useful section Su decreases accordingly. In the example illustrated in FIG. 9, the throttle member 21 has a cross-section in the form of a truncated semicircle. In a variant, it is still possible for the cross-section of the throttle member 21 to have a different shape, in particular a semicircle or polygon shape.

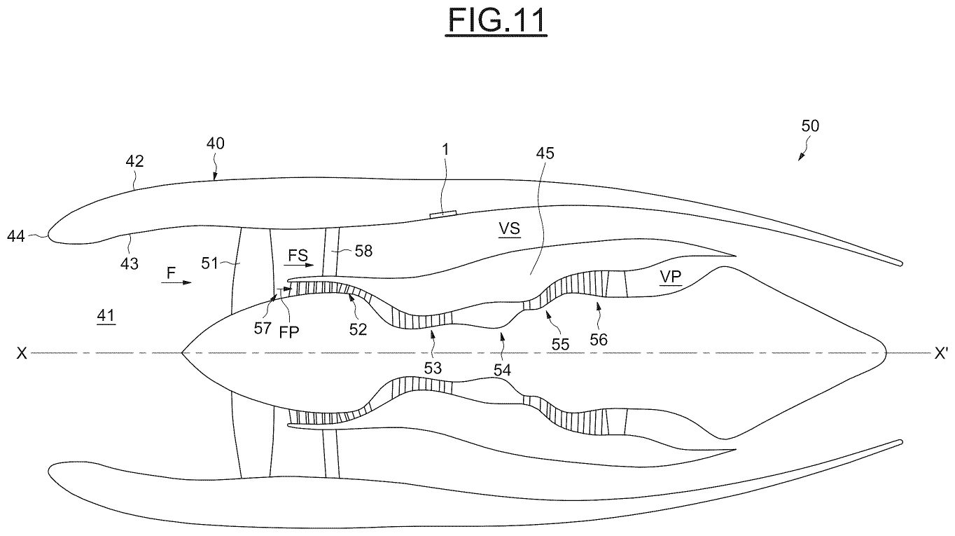

Advantageously, the above-described heat exchanger 1 is intended to equip a nacelle of a turbine engine or aircraft engine visible on FIG. 11.

FIG. 11 shows highly schematically an axial section of a turbine engine 50, of longitudinal general axis X-X′, for example of the twin-spool bypass turbojet engine type, comprising a fan 51, coupled to a gas turbine engine comprising a low-pressure compressor 52, a high-pressure compressor 53, an annular combustion chamber 54, a high-pressure turbine 55 and a low-pressure turbine 56.

The rotors of the high-pressure compressor and of the high-pressure turbine are connected by a high-pressure (HP) shaft (not shown) and form therewith a high-pressure spool. The rotors of the low-pressure compressor and of the low-pressure turbine are connected by a low-pressure (LP) shaft (not shown) and form therewith a low-pressure spool. The HP and LP shafts extend along a longitudinal axis X-X′ of the turbine engine 50.

The fan shaft is rotationally connected to the LP shaft directly or indirectly. It should be noted that the invention is not limited to such a turbine engine structure and could apply to a turbine engine with a different structure, for example to a turbine engine of the bypass turbojet engine type, in which the low-pressure compressor serves as a fan.

The nacelle 40 of the turbine engine comprises a housing 41 for the turbine engine 50 and has a tubular structure comprising an external fairing 42 defining an external aerodynamic surface and an internal fairing 43 defining an internal aerodynamic surface for flow through the turbine engine 50 and in particular the fan 51.

The internal and external fairings 42, 43 are connected upstream by an air-inlet lip 44 forming a leading edge of the nacelle 40.

The external and internal fairings 42, 43 delimit an outer structure usually comprising a fixed part and a movable part (not shown), such as for example thrust-reversal means.

The nacelle 40 further comprises an inner fixed structure 45, referred to as “inner fixed structure”, with the acronym “IFS”. The inner fixed structure 45 is concentric with the outer structure, at a downstream section, and surrounds the core of the turbojet engine 50 downstream of the fan 51.

These outer and inner structures define an annular flow duct, referred to as the secondary duct VS, intended to channel a cold airflow, referred to as secondary, circulating outside the turbojet engine 50.

Downstream of the fan 51, the main airflow F is separated by the inner fixed structure 45 of the nacelle, herein serving as a separation member, into a primary airflow FP and a secondary airflow FS.

The primary airflow FP travels through an internal passage or primary duct VP while entering the low-pressure compressor 52, for example at inlet guide vanes 57, with the acronym IGV.

The secondary airflow FS travels through an external annular passage or secondary duct VS, for example in the direction of outlet guide vanes 58, with the acronym OGV, and then to the outlet of the turbine engine.

The nacelle 40 is equipped with a heat exchanger 1, herein secured to the internal surface of the internal fairing 43. The heat exchanger 1 is secured in the secondary duct VS, so that the airflow circulating in the secondary duct VS is in contact with the second metal sheet 3 of the heat exchanger 1.

Alternatively, provision could be made for the heat exchanger 1 to be secured to the external surface of the internal structure 45 of the nacelle 40.

According to another variant, the heat exchanger 1 may be secured to the external surface of the external fairing 42 of the nacelle 40. Thus, the heat exchanger 1 can serve to cool a fluid from the secondary flow FS or from the external air.

According to yet another variant, the heat exchanger 1 could be secured to the internal surface of the internal structure 45, i.e. in the fluid flow of the primary duct VP.

Thus, the heat exchanger 1 can serve to heat a fluid from the primary flow FP

1. Heat exchanger, in particular for an aircraft nacelle, comprising a first metal sheet and a second metal sheet assembled together and a plurality of channels for distributing a fluid disposed between the first metal sheet and the second metal sheet, the heat exchanger further comprising inlet and outlet interfaces for said fluid, the exchanger further comprising distribution means for distributing said fluid defining for each distribution channel a flow section of said fluid, each of the distribution channels being connected to the inlet and outlet interfaces by such a flow section, said distribution channels being distributed over the entire perimeter of the inlet interface and/or the outlet interface.

2. Heat exchanger according to claim 1, wherein said flow section defined for each distribution channel has a value that depends on the length of said channel, so as to homogenize the flow rates of the distribution channels with each other.

3. Heat exchanger according to claim 1, wherein said plurality of channels comprises a first channel and a second channel with different cross-sections.

4. Heat exchanger according to claim 1, comprising a plate fastened to the second metal sheet and provided with studs disposed between the second and first metal sheets, so as to secure said interfaces to the first and second metal sheets by means of fastening means cooperating with said studs.

5. Heat exchanger according to claim 4, wherein said studs comprise threaded holes and said distribution means comprise a metal sheet provided with holes aligned with said threaded holes of the studs.

6. Heat exchanger according to claim 4, wherein the means for distributing said fluid comprise vertical walls disposed between the studs and the distribution channels, said walls being of constant thickness and oriented radially with respect to a longitudinal axis of said inlet interface and/or of said outlet interface.

7. Heat exchanger according to claim 4, wherein said distribution means comprise vertical walls of varying thickness disposed between said studs and the inlet and outlet ends of the distribution channels, so as to reduce turbulence due to the flow of the fluid.

8. Heat exchanger according to claim 7, wherein the distribution means of distributing said fluid comprise leading edges and trailing edges formed by circular arcs, the convexity of said arcs being directed towards a center of the plate.

9. Heat exchanger according to claim 4, wherein said plate is provided with throttle members intended to be placed in inlet ends and/or in outlet ends of the distribution channels, so as to create a reduction in the useful section of the channels at the location of the throttle members.

10. Turbine engine nacelle comprising at least one heat exchanger according to claim 1.
